(19) United States
(12) Patent Application Publication
(10) Pub. No.: US 2019/0378670 A1
(43) Pub. Date: Dec. 12, 2019

(54) ADJUSTABLE ADD-ON APPARATUSES FOR A SWITCH AND ASSOCIATED METHODS

(71) Applicant: PITYU CONTROLS INC., Edmonton (CA)

(72) Inventor: Stevan DOBI, Edmonton (CA)

(21) Appl. No.: 16/003,489

(22) Filed: Jun. 8, 2018

(51) Int. Cl. H01H 35/18; H01H 3/02; F04B 49/04; H01H 3/20

(52) U.S. Cl. CPC H01H 35/18; H01H 3/0206; H01H 13/186; H01H 3/20; F04B 49/04

(57) ABSTRACT

Adjustable add-on apparatuses for switches and associated methods are provided. In some embodiments, a float can actuate a first arm of the apparatus in response to a fluid level. The first arm can then actuate a second arm of the apparatus and, in turn, the second arm can open or close a switch, such as a micro switch. In some embodiments, the switch can be opened or closed through a lever and plunger assembly. Further, in some embodiments, apparatus can include a biasing means to bias the second arm into a first or second position without allowing it to rest in between the positions. Such apparatuses can include a micro switch or be retrofit to one. Methods of opening and closing a micro switch are also provided.

### TECHNICAL FIELD

This disclosure relates to switches, such as micro switches, and more specifically to adjustable add-on apparatuses for switches and associated methods.

### BACKGROUND

Switches, such as micro switches, can be used in controls, such as low water cut-off (LWCO) and feed controls. The switch can turn an associated pump on and off.

Existing controls can be too sensitive and end up opening or closing the switch too many times in response to small fluctuations. Accordingly, the associated pump is activated and deactivated too often, leading to wear. Such controls are not adjustable to change the sensitivity and can also be expensive.

Further, in existing controls, the force on the switch can be gradually reduced over time. In such cases, changes to the resistance cause production of heat when energized and potentially cause unwanted overheating and welding of the materials in the control.

Therefore there remains a need for apparatuses and methods that can overcome the shortcomings of the prior art.

### SUMMARY

Adjustable add-on apparatuses for switches and associated methods are provided. In some embodiments, a float can actuate a first arm of the apparatus in response to a fluid level. The first arm can then actuate a second arm of the apparatus and, in turn, the second arm can open or close a switch, such as a micro switch. In some embodiments, the switch can be opened or closed through a lever and plunger assembly. Further, in some embodiments, apparatus can include a biasing means to bias the second arm into a first or second position without allowing it to rest in between the positions. Such apparatuses can include a micro switch or be retrofit to one. Methods of opening and closing a micro switch are also provided.

Broadly stated, in some embodiments, an apparatus is provided for opening or closing a switch in response to a fluid level, the apparatus comprising: a float to detect the fluid level; a first arm to be activated by motion of the float; a second arm to be activated by motion of the first arm, the second arm for opening or closing the switch when activated.

In some embodiments, the apparatus can further comprising a biasing means for acting on the second arm to bias the second arm into a first or second position and away from a position there between. In some embodiments, the biasing means can comprise a spring.

In some embodiments, the apparatus can further comprise a switch to be opened or closed by the second arm. In some embodiments, the switch can be a micro switch. In some embodiments, the switch can comprise a lever and plunger assembly for opening or closing the switch.

In some embodiments, the float can have an upper and/or lower limit. In some embodiments, the second arm can have an open and/or closed limit. In some embodiments, the apparatus can further comprise a compression means for adjusting the biasing means by compression, in some cases, wherein the compression means comprises at least one set screw and nut. In some embodiments, the first arm can further comprise an adjustment means for altering contact with the second arm, in some cases, wherein the compression means comprises at least one set screw and nut. In some embodiments, the second arm can further comprise a second adjustment means for altering contact with the switch, in some cases, wherein the compression means comprises at least one set screw and nut.

Broadly stated, in some embodiments a method of monitoring a fluid level is provided, the method comprising: providing a float responsive to the fluid level; and harnessing the response of the float through a series of a first arm and a second arm to open or close a switch. In some embodiments, the method can further comprise the step of biasing the second arm into an open arm position or a closed arm position.

Broadly stated, in some embodiments a method of altering a fluid level is provided, the method comprising: providing a float responsive to the fluid level; harnessing the response of the float through a series of a first arm and a second arm to open or close a switch; and using the switch to activate or deactivate a device to alter the fluid level. In some embodiments, the method can further comprise the step of biasing the second arm into an open arm position or a closed arm position. In some embodiments, the device can be a pump.

### DESCRIPTION OF DRAWINGS

FIG. 1 is a perspective view of an embodiment of an adjustable add-on apparatus for a micro switch;

FIG. 2 is a front elevation view of the embodiment of FIG. 1;

FIG. 3 is a bottom planar view of the embodiment of FIG. 1;

FIG. 4 is a top planar view of the embodiment of FIG. 1;

FIG. 5 is a right side elevation view of the embodiment of FIG. 1;

FIG. 6 is a left side elevation view of the embodiment of FIG. 1;

FIG. 7 is a front elevation view of the embodiment of FIG. 1;

FIG. 8 is a magnified, cutaway, view of the embodiment of FIG. 2;

FIG. 9 is a front elevation view of the embodiment of FIG. 1 with the switch in a normally closed position; and

FIG. 10 is a front elevation view of the embodiment of FIG. 1 with the float raised and the switch in a normally open position.

### DETAILED DESCRIPTION

Adjustable add-on apparatuses for switches and associated methods are provided. In some embodiments, a float can actuate a first arm of the apparatus in response to a fluid level. The first arm can then actuate a second arm of the apparatus and, in turn, the second arm can open or close a switch, such as a micro switch. In some embodiments, the switch can be opened or closed through a lever and plunger assembly. Further, in some embodiments, apparatus can include a biasing means to bias the second arm into a first or second position without allowing it to rest in between the positions. Such apparatuses can include a micro switch or be retrofit to one. Methods of opening and closing a micro switch are also provided.

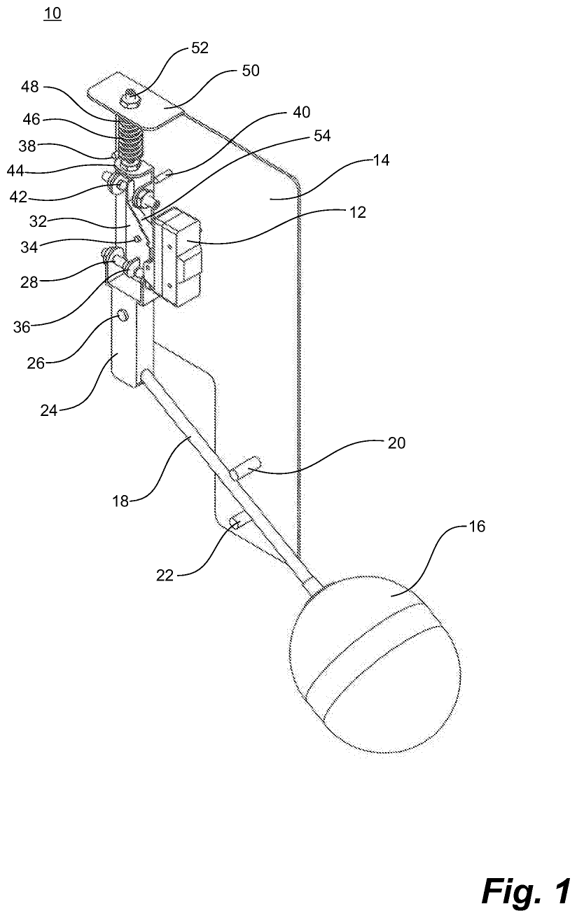

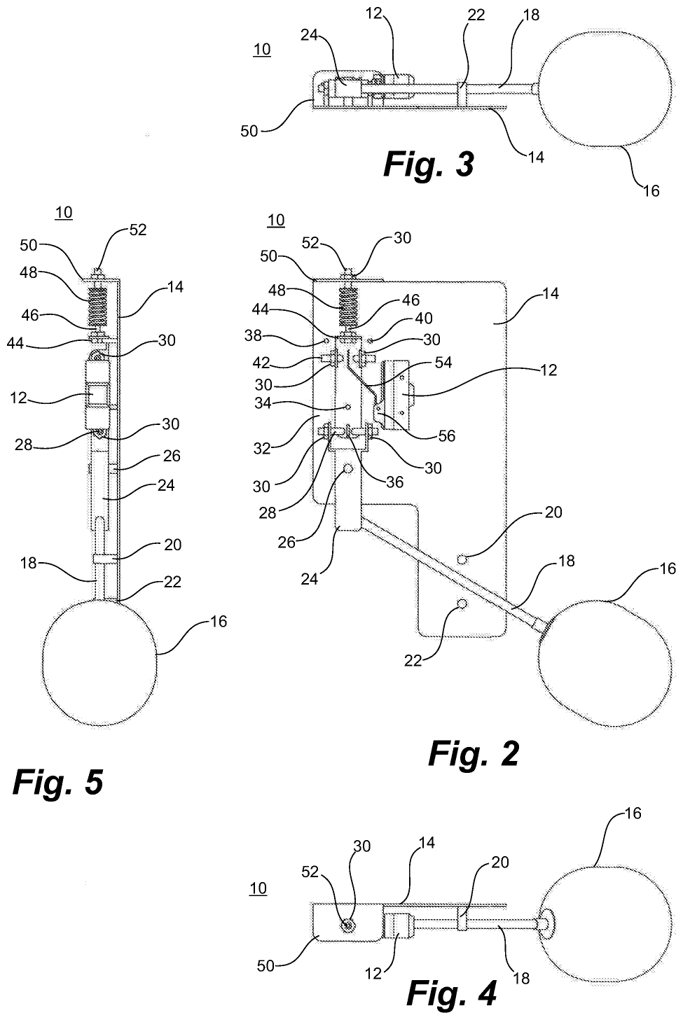

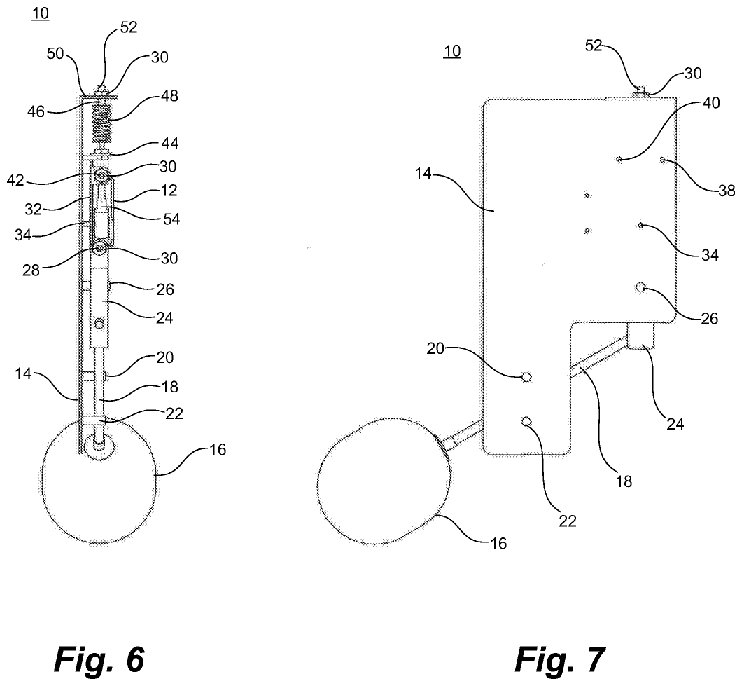

Referring to FIG. 1 to FIG. 7, an embodiment of an adjustable add-on apparatus 10 for a switch 12, such as a micro switch, is shown. In some embodiments, apparatus 10 can include a plate 14 to assist in fixing and spacing components of apparatus 10. It would be understood, however, that plate 14 is shown for convenience only, and components of apparatus 10 could be fixed and/or spaced in a number of ways using the context and environment available proximate switch 12.

A float 16 can be used to detect and monitor the level of a fluid. Float 16 can rise and fall with fluid level. Float 16 can have an upper limit 20 of motion and a lower limit 22 of motion. In some embodiments, these limits can be set by pins.

In some embodiments, float 16 can be attached, for example by rod 18, to a first arm 24 of apparatus 10. Accordingly, with motion of float 16, first arm 24 can be actuated and move correspondingly. In some embodiments, first arm can move about a first pivot point 26 in a pivoting manner. First arm 24 can also include an adjustment means such as a first set of adjustable set screws 28 which can be held in place by nuts 30.

In some embodiments, first set of adjustable set screws 28 can be positioned to contact second arm 32 at an inter-arm contact point 36. Accordingly, the pivoting motion of first arm 24 can cause actuation and motion of second arm 32. In some embodiments, motion of second arm can be a pivoting motion around second pivot point 34. In some embodiments, motion of second arm 32 can be limited by, for example a closed arm limit 38 and an open arm limit 40. In some embodiments, these limits can be set by pins. Second arm 32 can also include an adjustment means such as a second set of adjustable set screws 42 which can be held in place by nuts 30.

Through a biasing means connection 44, second arm 32 can also be in communication with a biasing means 46. In some embodiments, biasing means 46 can include a spring 48 with biasing means plate 50, however it would be understood that other suitable biasing means could be used. In some embodiments, biasing means can also include third set screw 52 and nut 30.

Biasing means 46 can bias second arm 32 to either first or second position, such as a closed arm position or an open arm position. In some embodiments, the closed arm position and open arm position can be set by closed arm limit 38 and open arm limit 40, respectively. Biasing means 46 can bias second arm 32 away from positions in between closed arm position and open arm position so that closed arm 32 is either in the closed arm position or the open arm position, but not in between positions for any substantial amount of time. In some embodiments the change in positions can be done quickly such that biasing means 46 has the effect of snapping second arm 32 from one position to the other.

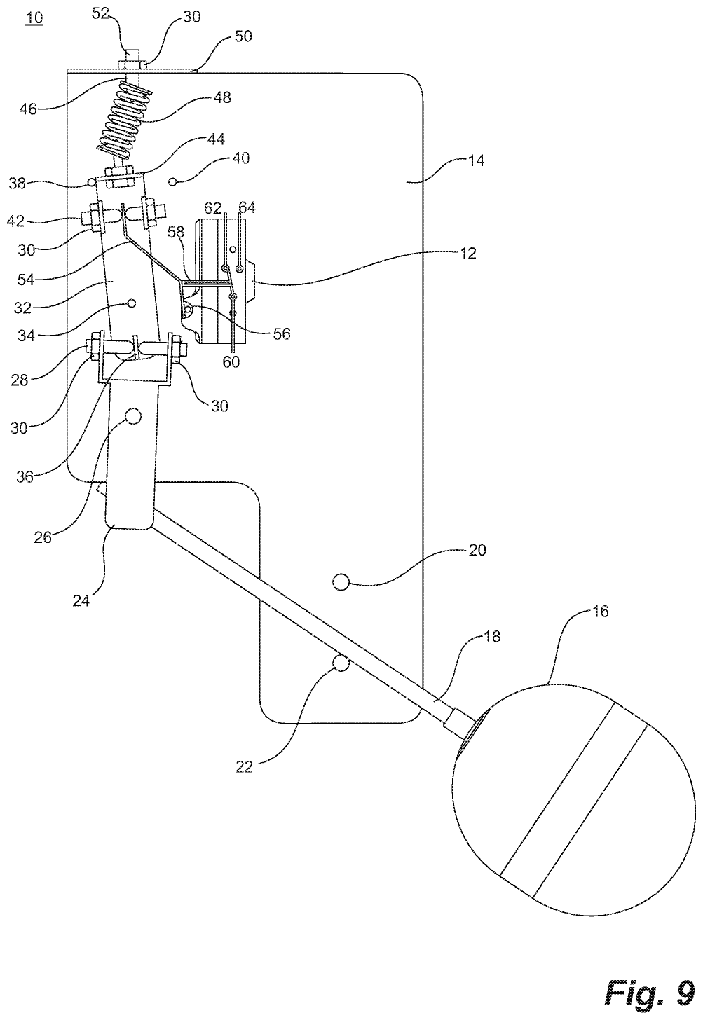

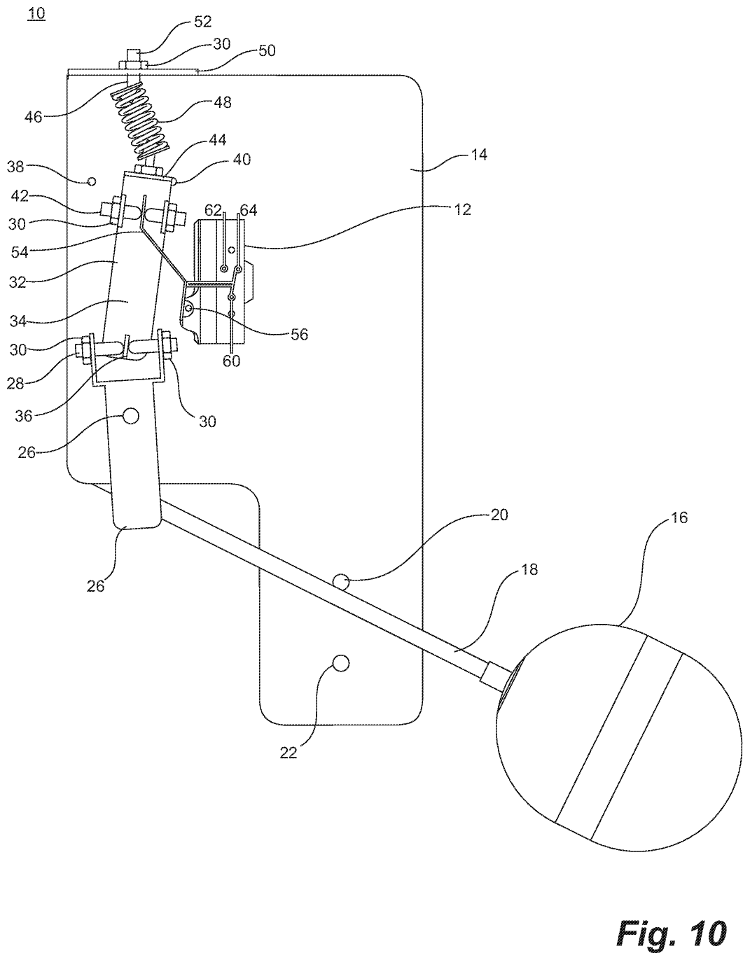

Second arm 32 can also convert switch 12 from a normally closed position to a normally open position. In some embodiments, second set screws 42 can be used to contact switch 12 via switch lever 54. Movement of second arm 32 can pull or push lever 54, for example around fulcrum 56, to open or close switch 12. Referring to FIG. 9 and FIG. 10, in some embodiments, motion of lever 54 can act on switch plunger 58 to close or open switch 12 by connecting common terminal 60 to normally closed terminal 62 or normally open terminal 64, respectively.

In operation, as shown in FIG. 9, when fluid level is low, float 16 will have a default position to rest against lower limit 22. Accordingly, first arm 24 will move to bring second arm 32 away from switch 12 and biasing means 46 will hold second arm into a closed arm position against closed arm limit 32. In such a position, lever 54 and plunger 58 can pull switch 12 into a normally closed position at normally closed terminal 62. With a circuit being closed by switch 12, a connected device can be activated. In some embodiments, a pump can be activated to provide fluid to feed a boiler.

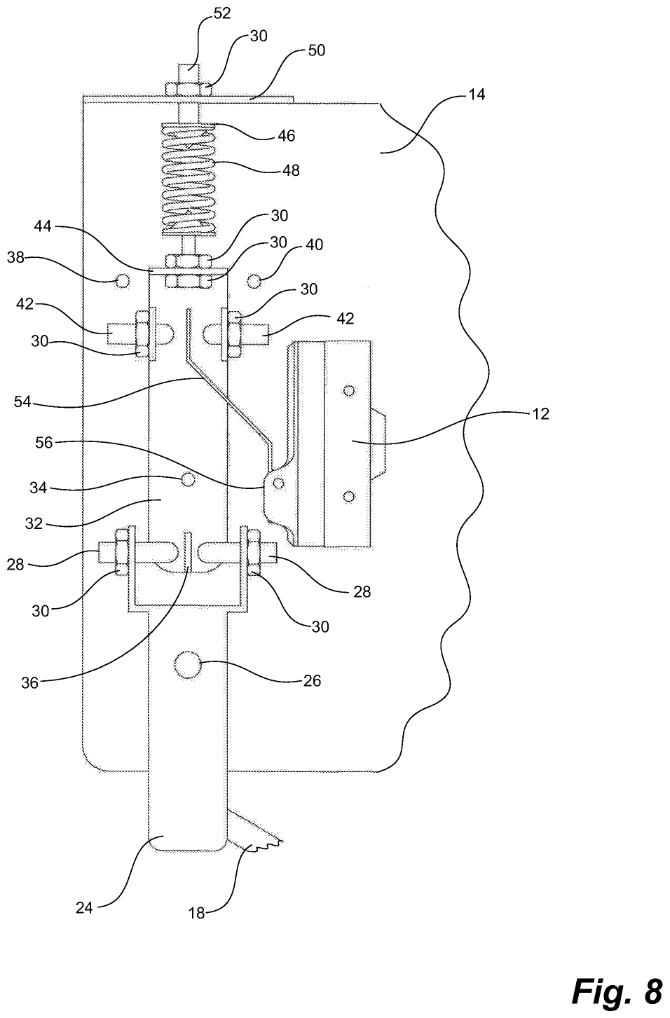

As the fluid level increases, float 16 can be lifted away from lower limit 22 towards upper limit 20. With such a motion, apparatus 10 can move from the configuration shown in FIG. 9 to that shown in FIG. 8. At this point, biasing means 46 will bias apparatus 10 into an open or closed position. As fluid level continues to increase, biasing means 46 can rapidly snap second arm 32 into an open arm position against open arm limit 40. In such a position, as shown in FIG. 10, lever 54 and plunger 58 can push switch 12 into a normally open position at normally open terminal 62. With the circuit being opened by switch 12, a connected device can be deactivated. In some embodiments, a pump can be deactivated to cease providing fluid to feed a boiler as float 16 indicates that the fluid has reached a desired level.

First set screws 28, second set screws 42, and third set screw 52, can be used to adjust, calibrate, and refine the function of apparatus 10. First set screws 28 can be used to adjust the fluid level range that float 16 and first arm 24 are allowed to move prior to causing and movement of second arm 32. Second set screws 42 can be used to adjust the bandwidth of switch 12. For example, if second set screws 42 are tightened around switch lever 54, there is little to no bandwidth, as lever 54 will move when second arm 32 moves. If second set screws 42 are loosened and do not contact lever 54, then second arm 32 can have a range of motion without moving lever 54. Such a range of motion can provide for a buffering effect by reducing the activation of switch 12 due to fluid waves, bumps, or other inconstancies. Third set screw 52 can act as a compression means and be used to adjust the compression and biasing force of biasing means 46.

Although particular embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

I claim:

1. An apparatus for opening or closing a switch in response to a fluid level, the apparatus comprising:
a float to detect the fluid level;
a first arm to be activated by motion of the float;
a second arm to be activated by motion of the first arm, the second arm for opening or closing the switch when activated.

2. The apparatus of claim 1 further comprising a biasing means for acting on the second arm to bias the second arm into a first or second position and away from a position there between.

3. The apparatus of claim 2 wherein the biasing means comprises a spring.

4. The apparatus of claim 1 wherein the apparatus further comprises a switch to be opened or closed by the second arm.

5. The apparatus of claim 4 wherein the switch is a micro switch.

6. The apparatus of claim 4 wherein the switch comprises a lever and plunger assembly for opening or closing the switch.

7. The apparatus of claim 1 wherein the float has an upper and lower limit.

8. The apparatus of claim 1 wherein the second arm has an open and closed limit.

9. The apparatus of claim 2 further comprising a compression means for adjusting the biasing means by compression.

10. The apparatus of claim 9 wherein the compression means comprises at least one set screw and nut.

11. The apparatus of claim 1 wherein the first arm further comprises an adjustment means for altering contact with the second arm.

12. The apparatus of claim 11 wherein the adjustment means comprises at least one set screw and nut.

13. The apparatus of claim 1 wherein the second arm further comprises a second adjustment means for altering contact with the switch.

14. The apparatus of claim 13 wherein the adjustment means comprises at least one set screw and nut.

15. A method of monitoring a fluid level, the method comprising:
providing a float responsive to the fluid level; and
harnessing the response of the float through a series of a first arm and a second arm to open or close a switch.

16. The method of claim 15 further comprising the step of biasing the second arm into an open arm position or a closed arm position.

17. A method of altering a fluid level, the method comprising:
providing a float responsive to the fluid level;
harnessing the response of the float through a series of a first arm and a second arm to open or close a switch; and
using the switch to activate or deactivate a device to alter the fluid level.

18. The method of claim 17 further comprising the step of biasing the second arm into an open arm position or a closed arm position.

19. The method of claim 17 wherein the device is a pump.
